(19) United States
(12) Patent Application Publication
(10) Pub. No.: US 2007/0096917 A1
(43) Pub. Date: May 3, 2007

(54) Label of radio frequency identification by thermal transfer printing antenna

(76) Inventor: San-Lien Yang, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 11/263,961

(22) Filed: Nov. 2, 2005

(51) Int. Cl. G08B 13/14; H01Q 17/00

(52) U.S. Cl. 340/572.8; 340/572.7; 29/601

(57) ABSTRACT

A thermal transfer printing antenna RFID label by a thermal transfer printer includes mainly a conductive metal foil, a thermal transfer RFID antenna substratum and a RFID chip. A conductive metal foil is used as a material to thermal transfer the antenna circuits onto the substratum by a thermal transfer printer, forming the antenna substratum, which is then adhered with the RFID chip by a flip chip bonder or a wire bonder. The process can obtain a quick mass production and a lower cost for the label.

### BACKGROUND OF THE INVENTION

1. Field of the invention

This invention relates to a label of radio frequency identification (hereafter:RFID) by a thermal transfer printing antenna, particularly to one using a conductive metal foil as a material to print an antenna on a substratum by a thermal transfer printer to form an antenna substratum, which is then adhered with a RFID chip by a flip chip bonder or a wire bonder, obtaining a quick mass production and a lower cost of the RFID label.

2. Description of the Prior Art

Commonly, in order to speed up passing of an object through a checkpoint or a cashier, an identity component is always applied. Most of the identity data used conventionally are based on a Barcode label or a current RFID label. Although the Barcode label attached on an object is easy to produce, low in cost and not affected by metal or conductive environment or electromagnetic wave, it is easy to be damaged by a foreign force, disabling it to be identified, and can't be used repeatedly and updated. As for the current RFID label, although it is not easy to be damaged and capable to be used repeatedly and updated, but, due to a conductive metal antenna having to be produced by etching or carving, it costs high and needs a long time for manufacturing. So this invention has been devised to improve the disadvantages mentioned above.

So the conventional identity component has the following drawbacks.

1. The identity component is a Barcode attached on a goods, and it is easily to be damaged or fall off, becoming impossible to be identified, and it can not be used repeatedly or updated

2. The identity compoments is a current RFID label, which costs high and need rather a long time to make.

### SUMMARY OF THE INVENTION

The prime object of this invention is to offer a RFID label by thermal transfer printing antenna.

The main characteristics of the invention are mainly a thermal transfer printing antenna RFID substratum and a RFID chip. A conductive metal foil is used as a material to transfer the antenna onto a substratum by thermal transfer printing to form the antenna substratum, which is then adhered with the RFID chip by a flip chip bonder or a wire bonder. Then, a protective resin is coated on the chip, forming a single-layer thermal transfer printing antenna RFID label. The single-layer thermal transfer printing antenna RFID label can be further adhered with an upper protective layer to form a multi-layer thermal transfer printing antenna RFID label. The process can result in a quick mass production and a lower cost.

### BRIEF DESCRIPTION OF DRAWINGS

This invention is better understood by referring to the accompanying drawings, wherein:

FIG. 1 is a perspective view of a preferred embodiment of a thermal transfer printing antenna RFID label in the present invention;

FIG. 2 is a perspective view of a conductive metal foil of the preferred embodiment in the present invention;

FIG. 3 is a flow chart of manufacturing a conductive metal foil for thermal transfer printing of the preferred embodiment in the present invention;

FIG. 4 is a flow chart of manufacturing a thermal transfer printing RFID antenna substratum of the preferred embodiment in the present invention;

FIG. 5 is a flow chart of manufacturing the thermal transfer printing antenna RFID label of the preferred embodiment in the present invention; and

FIG. 6 is a perspective view of a preferred embodiment of a double-layer thermal transfer printing antenna RFID label in the present invention.

### DETAILED DESCRIPTION OF THE PREFERRED EMBODIMENT

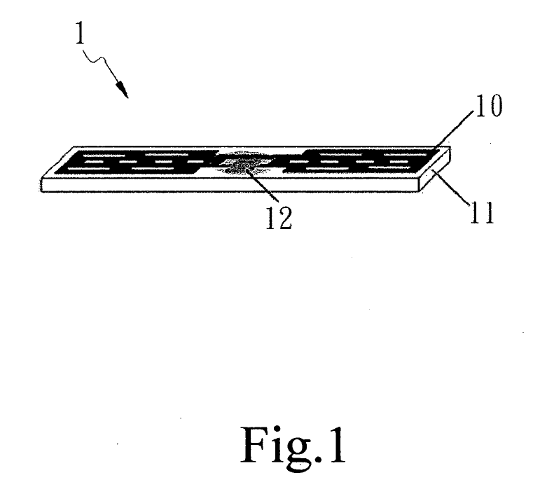

As shown in FIG. 1, a preferred embodiment of a thermal transfer printing antenna RFID label by a thermal transfer printing 1 in the present invention includes mainly an antenna 10, a RFID antenna substratum 11 and a RFID chip 12. Their related technologies are described as below.

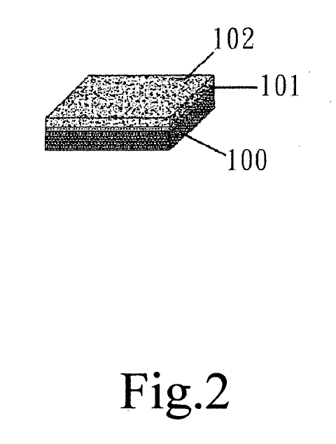

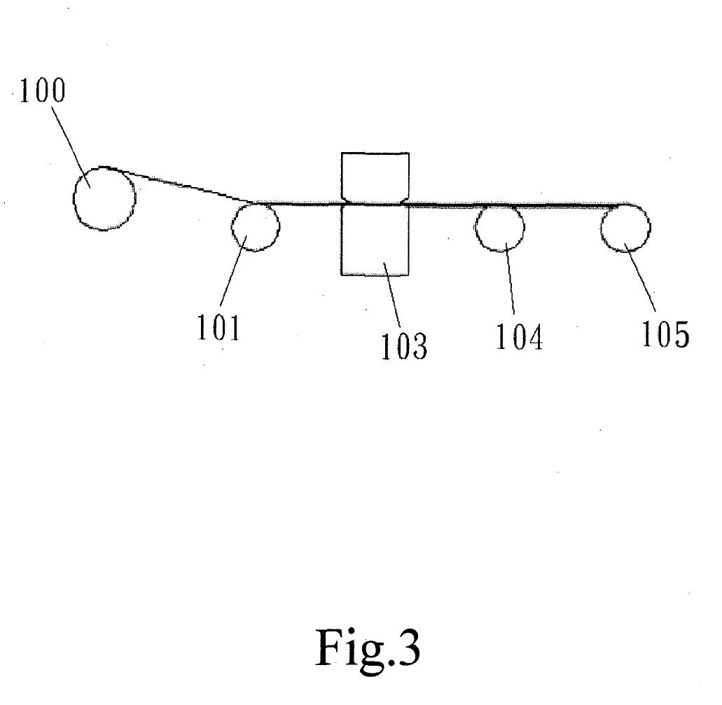

As shown in FIGS. 2 and 3, for making a thermal transfer printable conductive metal foil 15, a carrier 100 is first coated with a isolated layer 101 and then, plating the metallic solution on the isolated layer 101 by means of vacuum plating, thus forming a conductive metal foil 103, which is successively coated with a glue 104 to make a thermal transfer printing conductive metal foil 105 The carrier 100 is used as a substrate for vacuum plating. The isolated layer 101 is located between the carrier 100 and the metal foil 102, enabling the metal foil 102 to be peeled off the carrier 100 easily. Thus, the metal foil 103 is constituted as shown in FIG. 2. The glue layer 104 is an adhesive to combine together the conductive metal foil 103 with a substratum 110.

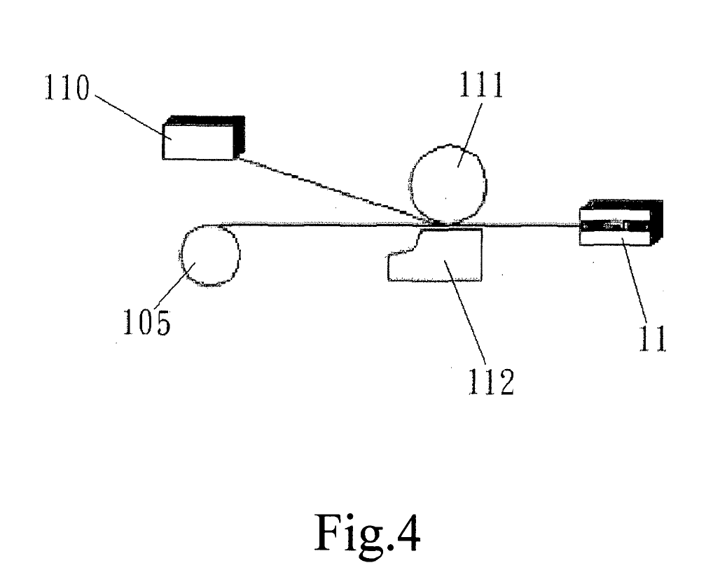

As shown in FIG. 4, by moving down a thermal transfer printer 111 and a transfer zinc plate mold 112, the conductive metal foil 105 placed on the transfer zinc plate mold 112 is pressed down by the thermal printer 111 to form the antenna 10 from the conductive metal antenna 105 on the substratum 110, becoming the antenna substratum 11. Owing to a quick mass production obtained by the thermal transfer printer 111 and the transfer zinc plate mold 112, cost can be lowered. The substrate 110 used for carrying out thermal transfer printing of the antenna 10 can be a paper, a glass-fiber reinforced plastic or various plastics. The transfer zinc plate mold 112, a relief metal plate, is made primarily by etching or carving a zinc plate with a shape of the antenna 10.

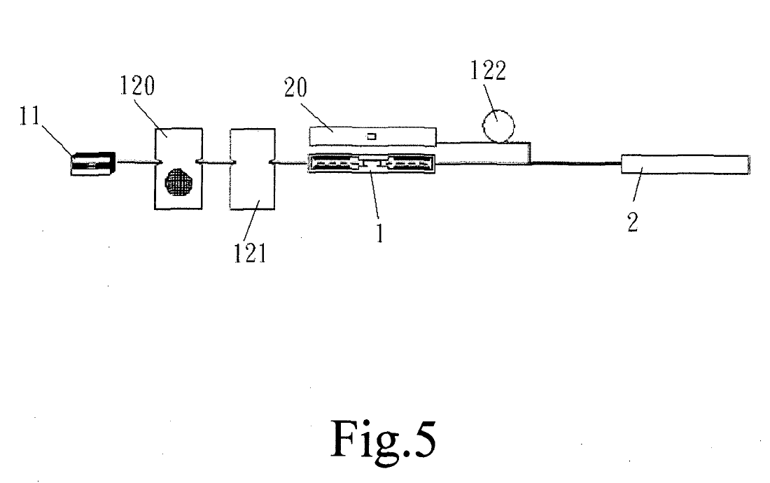

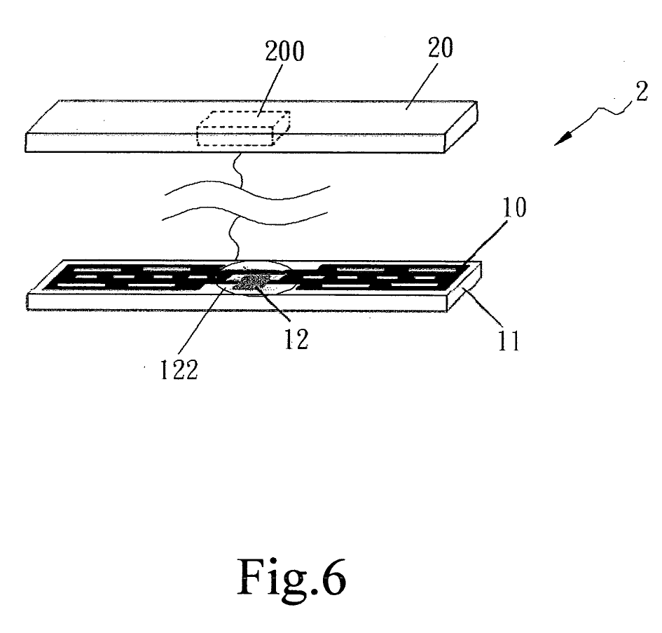

Next, FIGS. 5 and 6 show a flowing chart of making a thermal transfer printing antenna RFID label.

At first, a RFID chip 12 is adhered on the antenna substratum 11 in a flip chip bonder or a wire bonder 120. Next, a protective resin is coated on the chip 12 by a resin dispenser 121 to form the single-layer thermal transfer printing antenna RFID label 1. In addition, an upper layer 20 with a resin-filled cavity 200 is adhered on the single-layer thermal transfer printing antenna RFID label 1 to make a double-layer thermal transfer printing antenna RFID label 2. The upper layer 20 is to protect the chip 12 and the antenna 10.

Finally, the advantage of the RFID label by a thermal transfer printing antenna is described as below:

1. The label can be produced with a low cost by means of the thermal transfer printer 111 and the transfer zinc plate mold 112, the conductive metal foil 105 is used as a material to print the antenna 10 on the substratum 110 to become the antenna substratum 11, achieving a quick mass production and a lower cost.

While the preferred embodiment of the invention has been described above, it will be recognized and understood that various modifications may be made therein and the appended claims are intended to cover all such modifications that may fall within the spirit and scope of the invention.

What is claimed is:

1. A thermal transfer printing antenna RFID label comprising:
a conductive metal foil
a thermal transfer printing RFID antenna substratum
a RFID chip adhered on said RFID antenna substratum.

2. A thermal transfer printing antenna RFID label as claimed in claim 1, wherein the material of said antenna is said conductive metal foil manufactured by vacuum plating.

3. A thermal transfer printing antenna RFID label as claimed in claim 1, wherein said antenna is printed on said RFID antenna substratum by thermal transfer printer.

4. A thermal transfer printing antenna RFID label as claimed in claim 1, wherein said RFID chip is adhered on said antenna substratum by a flip chip machine.

5. A thermal transfer printing antenna label as claimed in claim 1, wherein said RFID chip is adhered on said antenna substratum by a wire bonder.

6. A thermal transfer printing antenna RFID label as claimed in claim 1, wherein the material of said RFID antenna substratum is a sheet of paper.

7. A thermal transfer printing antenna RFID label as claimed in claim 1, wherein the material of said RFID antenna substratum is a glass-fiber reinforced plastic.

8. A thermal transfer printing antenna RFID label as claimed in claim 1, wherein the material of said RFID antenna substratum is a plastic.
